(19) United States
(12) Patent Application Publication
(10) Pub. No.: US 2016/0210912 A1
(43) Pub. Date: Jul. 21, 2016

(54) DISPLAY APPARATUS AND METHOD OF CONTROLLING SAME

(71) Applicant: CANON KABUSHIKI KAISHA, Tokyo (JP)

(72) Inventor: Mitsuru Tada, Machida-shi (JP)

(21) Appl. No.: 15/000,828

(22) Filed: Jan. 19, 2016

(30) Foreign Application Priority Data
Jan. 20, 2015 (JP) 2015-008465

(51) Int. Cl. G09G 3/36

(52) U.S. Cl. CPC G09G 3/3607; G09G 2320/0233; G09G 2320/0242

(57) ABSTRACT

A display apparatus includes: a light-emitter configured to have a plurality of light sources corresponding to a plurality of divided areas; a display unit configured to display an image by transmission of light from the light-emitter with a transmittance based on input image data; a determining unit configured to determine emission brightness of each light source separately, based on the input image data; a storage configured to store color change information; and a color corrector configured to perform color correction processing based on the color change information.

### BACKGROUND OF THE INVENTION

1. Field of the Invention

The present invention relates to a display apparatus and a method of controlling the same.

2. Description of the Related Art

As a conventional technique relating to a liquid crystal display apparatus, there is local dimming control in which a backlight having a plurality of light sources corresponding to a plurality of divided areas forming the area of a screen is used to separately control the emission brightness of the plurality of light sources in accordance with the brightness of input image data (see Japanese Patent Application Laid-open No. 2009-271349). The local dimming control is performed also in backlight using a light source having three colored LEDs, i.e., a red LED, a green LED, and a blue LED (see Japanese Patent Application Laid-open No. 2012-93786).

It is known that, as the distance increases from the position of a light source, the color of light (source light) emitted from the light source changes. For example, in a liquid crystal display apparatus, an optical member that causes an optical change in light emitted from a backlight is provided between the backlight and a liquid crystal panel. The optical member is a reflective sheet, a diffusion plate, a diffusion sheet, a brightness enhancement film (BEF), a dual brightness enhancement film (DBEF), or the like. By causing an optical change in source light with the optical member, the spectral characteristics of the source light change, and the color of the source light changes.

It is also known that the source light leaks to other divided areas.

Since the color of light (source light) emitted from the light source changes as the distance increases from the position of the light source, the color of the source light after leakage to other divided areas differs from the color before leakage. Therefore, the display color (color of a screen) is changed by the leakage of source light to other divided areas. Such a change in display color appears significantly in the case of performing the local dimming control.

However, in techniques disclosed in Japanese Patent Application Laid-open No. 2009-271349 and Japanese Patent Application Laid-open No. 2012-93786, the brightness of source light is not taken into consideration. Therefore, the change in display color described above cannot be prevented.

### SUMMARY OF THE INVENTION

The present invention provides a technique that can prevent a change in display color due to leakage of light emitted from a light source to other divided areas.

The present invention in its first aspect provides a display apparatus comprising:

a light-emitter configured to have a plurality of light sources corresponding to a plurality of divided areas forming an area of a screen;

a display unit configured to display an image on the screen by transmission of light from the light-emitter with a transmittance based on input image data;

a determining unit configured to determine emission brightness of each light source separately, based on the input image data;

a storage configured to store color change information showing a change in color of light from the light source in an in-plane direction of the screen; and

a color corrector configured to perform color correction processing of correcting at least one of a color of each pixel of image data in a target area, and an emission color of the light source corresponding to the target area, based on the color change information.

The present invention in its second aspect provides a method for controlling a display apparatus having:

a light-emitter configured to have a plurality of light sources corresponding to a plurality of divided areas forming an area of a screen;

a display unit configured to display an image on the screen by transmission of light from the light-emitter with a transmittance based on input image data; and

a storage configured to store color change information showing a change in color of light from the light source in an in-plane direction of the screen,

the method comprising:

a determining step of determining emission brightness of each light source separately, based on the input image data; and

a color correcting step of performing color correction processing of correcting at least one of a color of each pixel of image data in a target area, and an emission color of the light source corresponding to the target area, based on the color change information.

The present invention in its third aspect provides a non-transitory computer readable medium that stores a program, wherein the program causes a computer to execute a method for controlling a display apparatus having:

a light-emitter configured to have a plurality of light sources corresponding to a plurality of divided areas forming an area of a screen;

a display unit configured to display an image on the screen by transmission of light from the light-emitter with a transmittance based on input image data; and

a storage configured to store color change information showing a change in color of light from the light source in an in-plane direction of the screen,

the method including:

a determining step of determining emission brightness of each light source separately, based on the input image data; and

a color correcting step of performing color correction processing of correcting at least one of a color of each pixel of image data in a target area, and an emission color of the light source corresponding to the target area, based on the color change information.

With the present invention, a change in display color due to leakage of light emitted from a light source to other divided areas can be prevented.

Further features of the present invention will become apparent from the following description of exemplary embodiments with reference to the attached drawings.

### BRIEF DESCRIPTION OF THE DRAWINGS

FIG. 1 is a block diagram showing one example of the configuration of a display apparatus according to Embodiment 1;

FIGS. 2A to 2C are schematic diagrams for illustrating the problem of a conventional technique;

FIG. 3 is a schematic diagram showing one example of a plurality of divided areas according to Embodiment 1;

FIG. 4 is a diagram showing one example of brightness change information according to Embodiment 1;

FIG. 5 is a flowchart showing one example of corresponding brightness calculation processing according to Embodiment 1;

FIG. 6 is a diagram showing one example of first color change information according to Embodiment 1;

FIG. 7 is a flowchart showing one example of corresponding color calculation processing according to Embodiment 1; and

FIG. 8 is a block diagram showing one example of the configuration of a display apparatus according to Embodiment 2.

### DESCRIPTION OF THE EMBODIMENTS

### Embodiment 1

A display apparatus and a method of controlling the same according to Embodiment 1 of the present invention will be described below. In this embodiment, an example of a case where the display apparatus is a liquid crystal display apparatus will be described. However, the display apparatus according to this embodiment is not limited to a liquid crystal display apparatus. The display apparatus according to this embodiment may be any apparatus having a light-emitting unit and a display panel that displays an image on a screen by transmission of light from the light-emitting unit with a transmittance based on input image data (image data that has been input to the display apparatus). For example, the display apparatus according to this embodiment may be a micro electro mechanical system (MEMS) display apparatus using a MEMS shutter instead of a liquid crystal element.

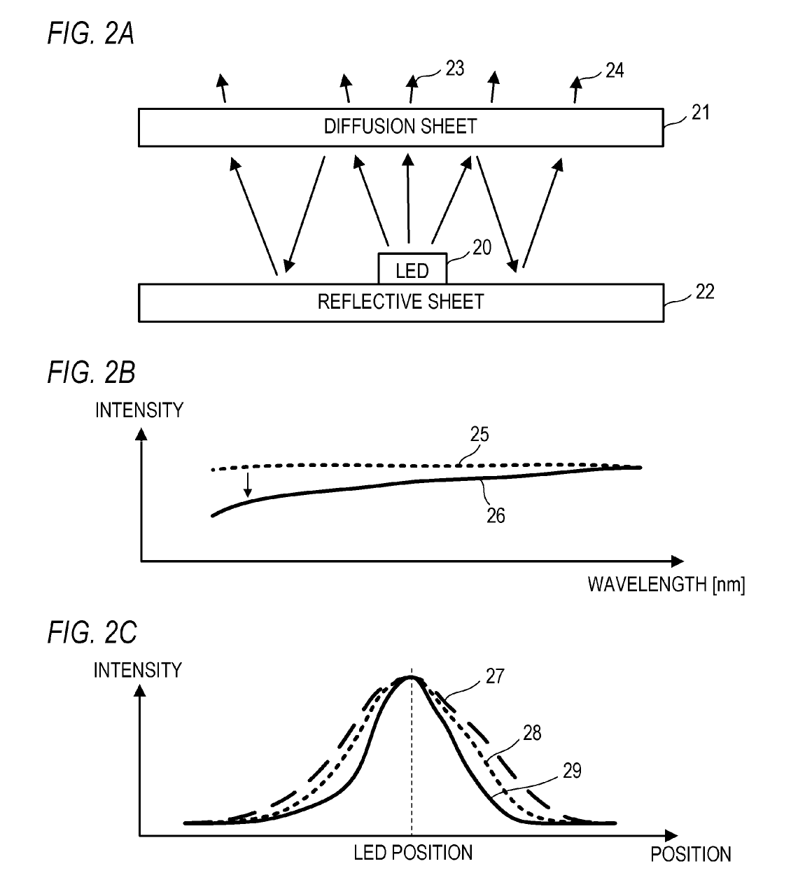

First, the problem of a conventional technique will be described using FIGS. 2A to 2C.

It is known that, as the distance increases from the position of a light source, the color of light (source light) emitted from the light source changes. For example, generally, light (source light) emitted from a light source included in a backlight is guided to a liquid crystal panel through repetition of transmission and reflection of the source light with a diffusion sheet included in the backlight, reflection of the source light with a reflective sheet included in the backlight, and the like. Generally, due to the transmission and reflection, the spectral characteristics of the source light change, and the color of the source light changes. The light source of the backlight has one or more light-emitting elements. As the light-emitting element, a light-emitting diode (LED), an organic EL element, a cold-cathode tube element, or the like is used. Instead of the diffusion sheet, a diffusion plate having a certain amount of thickness may be used. Instead of the reflective sheet, a reflective plate having a certain amount of thickness may be used.

FIG. 2A is a schematic diagram showing one example of diffusion of source light emitted from a white LED 20. The white LED 20 is an LED that emits white light. Source light 23 is light that has been emitted from the white LED 20 and transmitted through a diffusion sheet 21. Source light 24 is light that has been emitted from the white LED, reflected by the diffusion sheet 21, reflected again by a reflective sheet 22, and transmitted through the diffusion sheet 21.

FIG. 2B is a schematic diagram showing one example of a change in spectral characteristics of source light, due to reflection by the diffusion sheet 21 or the reflective sheet 22. As shown in FIG. 2B, spectral characteristics 26 after reflection is lower in intensity on the short-wavelength side, compared to spectral characteristics 25 before reflection. In this manner, upon every reflection, the intensity on the short-wavelength side decreases, and the color of the source light approaches red. The source light 23 is light that has not been reflected by the diffusion sheet 21 and the reflective sheet 22, whereas the source light 24 is light that has been reflected by the diffusion sheet 21 and the reflective sheet 22. Therefore, the color of the source light 24 is closer to red, compared to the color of the source light 23.

FIG. 2C is a schematic diagram showing one example of a change in XYZ tristimulus values of source light emitted from the white LED 20. An intensity change 27 is a change in X value in the XYZ tristimulus values, an intensity change 28 is a change in Y value in the XYZ tristimulus values, and an intensity change 29 is a change in Z value in the XYZ tristimulus values. As shown in FIG. 2C, the ratio (intensity ratio) among the X value, the Y value, and the Z value changes in accordance with an increase in distance from the white LED. Such a change in intensity ratio indicates that the color of source light changes in accordance with an increase in distance from the white LED.

The change in the color of source light as described above causes a change in display color (color of the screen). Such a change in display color appears significantly in the case of performing the local dimming control. The local dimming control is light source control in which the emission brightness of a plurality of light sources is controlled separately.

However, in the conventional technique, only the intensity change 28 in brightness value (Y value) has been taken into consideration. Therefore, the conventional technique cannot prevent the change in display color described above.

In this embodiment, the change in color of source light as described above is taken into consideration. Accordingly, the change in display color described above can be prevented.

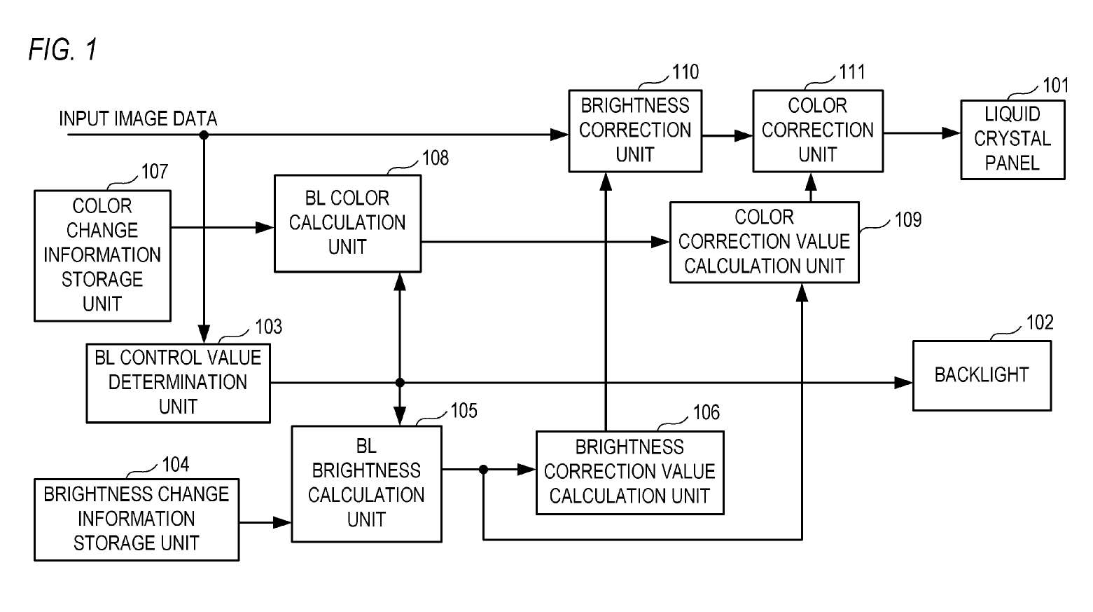

FIG. 1 is a block diagram showing one example of the configuration of the display apparatus according this embodiment. As shown in FIG. 1, the display apparatus according to this embodiment has a liquid crystal panel 101, a backlight 102, a BL control value determination unit 103, a brightness change information storage unit 104, a BL brightness calculation unit 105, a brightness correction value calculation unit 106, a color change information storage unit 107, a BL color calculation unit 108, a color correction value calculation unit 109, a brightness correction unit 110, a color correction unit 111, and the like.

The liquid crystal panel 101 is a display panel that displays an image on the screen by transmission of light from the backlight 102 with a transmittance based on input image data. In this embodiment, the liquid crystal panel 101 has three liquid crystal elements, i.e., an R element that displays red, a G element that displays green, and a B element that displays blue, for each pixel of image data. The transmittance of each liquid crystal element is controlled to a value in accordance with image data output from the color correction unit 111. By transmission of light from the backlight 102 through each liquid crystal element with the transmittance in accordance with the image data output from the color correction unit 111, an image is displayed on the screen.

The backlight 102 is the light-emitting unit provided on the back side of the liquid crystal panel 101. The backlight 102 has a plurality of light sources corresponding to a plurality of divided areas forming the area of the screen. The plurality of light sources can be driven (controlled) separately. In this embodiment, the emission color of the light source is white. The light source has one or more light-emitting elements. As the light-emitting element, a light-emitting diode (LED), an organic EL element, a cold-cathode tube element, or the like is used. In this embodiment, each light source is driven in accordance with a BL control value bd output from the BL control value determination unit 103. The BL control value bd represents the emission brightness of the light source.

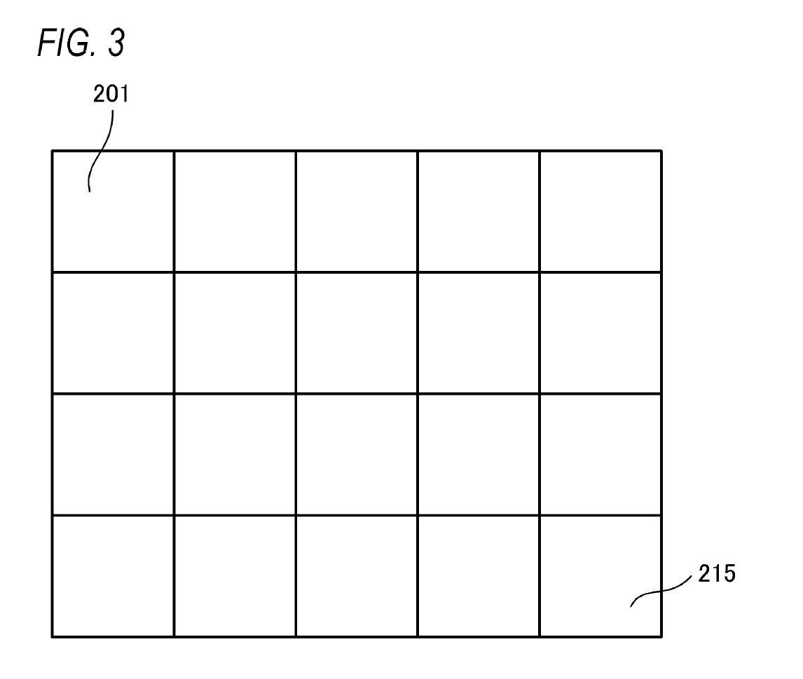

FIG. 3 is a schematic diagram showing one example of the plurality of divided areas. In the example of FIG. 3, the area of the screen is formed of 20 divided areas in 4 rows and 5 columns. Reference numeral 201 denotes the divided area in the 1st row and the 1st column, and reference numeral 215 denotes the divided area in the 4th row and the 5th column. In this embodiment, the BL control value bd of the light source corresponding to the divided area in the m-th row and the n-th column is referred to as “BL control value bdmn”.

The number of the divided areas in the horizontal direction may be more or less than five. The number of the divided areas in the horizontal direction may be one. The number of the divided areas in the vertical direction may be more or less than four. The number of the divided areas in the vertical direction may be one.

(BL Control Value Determination Unit)

The BL control value determination unit 103 determines the emission brightness of each light source separately, based on input image data. In this embodiment, the BL control value determination unit 103 calculates, for each divided area, the BL control value bd of the light source corresponding to a first target area that is the divided area, based on the brightness of the input image data in the first target area. The BL control value determination unit 103 outputs the BL control value bd of each light source to the backlight 102, the BL brightness calculation unit 105, and the BL color calculation unit 108.

A method of calculating the BL control value bd will be described.

((Step 1))

First, the BL control value determination unit 103 transforms each pixel value of input image data to a brightness value. For example, in the case where the pixel value of the input image data is an RGB value (combination of an R value, a G value, and a B value), a brightness value Y is calculated using the following expression 1. The R value (“R” in expression 1) is a gradation value corresponding to red. The G value (“G” in expression 1) is a gradation value corresponding to green. The B value (“B” in expression 1) is a gradation value corresponding to blue. In expression 1, α, β, and γ are predetermined coefficients (brightness transformation coefficients) for transforming the RGB value to the Y value.

Y=α×R+β×G+γ×B (Expression 1)

((Step 2))

Next, the BL control value determination unit 103 calculates, for each divided area, the brightness (luminance) of the input image data in the divided area. Specifically, the BL control value determination unit 103 calculates an average value YAG of the brightness values Y of respective pixels in the first target area (brightness values Y calculated in step 1), as the brightness of the input image data in the first target area. In this embodiment, the brightness YAG of the input image data in the divided area in the m-th row and the n-th column is referred to as “brightness YAGmn”. The brightness calculated with respect to the first target area is set as emission brightness of the light source corresponding to the first target area.

((Step 3))

For each divided area, the BL control value determination unit 103 transforms the brightness YAG of the divided area (brightness YAG calculated in step 2) to the BL control value bd. The BL control value bd obtained from the brightness YAG of the first target area is set as the BL control value bd of the light source corresponding to the first target area. In this embodiment, the BL control value bdmn of the light source corresponding to the divided area in the m-th row and the n-th column is calculated using the following expression 2. In expression 2, “Ymax” is the maximum value of the brightness value (maximum brightness value) that the input image data can take.

bdmn=YAGmn÷Ymax (Expression 2)

In this embodiment, an example of determining the emission brightness using the average value of the brightness values has been described, but this is not limiting. For example the emission brightness of the light source corresponding to the first target area may be determined using a different feature amount of the input image data in the first target area. For example, a maximum value, minimum value, median value, mode value, histogram, or the like of the brightness value can be used as the different feature amount. A maximum value, minimum value, median value, mode value, histogram, or the like of the pixel value can also be used as the different feature amount. A maximum value, minimum value, median value, mode value, histogram, or the like of the gradation value (at least one of the R value, the G value, and the B value) can also be used as the different feature amount. The average value, the maximum value, the minimum value, the median value, and the mode value can be called a “representative value”.

A method of determining the emission brightness is not limited to the method described above. For example, the emission brightness may be determined using a feature amount of the input image data in an area different from the divided area.

In this embodiment, the BL control value bd is an integer in a range of 0 to 255 that represents higher emission brightness with a larger number. However, this is not limiting. The range of value that the BL control value bd can take may be broader or narrower than the range of 0 to 255. The BL control value bd may represent higher emission brightness with a smaller number.

(Brightness Change Information Storage Unit)

The brightness change information storage unit 104 is a second storage unit that stores brightness change information F. The brightness change information F is information showing a change in brightness of light from the light source in an in-plane direction of the screen. For example, the brightness change information F is information showing a change in Y value in the XYZ tristimulus values of light from the light source in the in-plane direction. For example, the brightness change information F is information representing the brightness of light from the light source in each divided area. In this embodiment, a table representing, for each divided area, the brightness, in the respective divided areas, of light from the light source corresponding to the divided area as the brightness change information F corresponding to the divided area is prepared. In this embodiment, the brightness change information F corresponding to the divided area in the m-th row and the n-th column is referred to as “brightness change information Fmn”. The brightness represented by the brightness change information Fmn (brightness, in the divided area in the m′-th row and the n′-th column, of light from the light source corresponding to the divided area in the m-th row and the n-th column) is referred to as “brightness Fmnm′n′”. In this embodiment, the brightness Fmnm′n′ is a relative value for luminance that is 1 when m=m′ and n=n′.

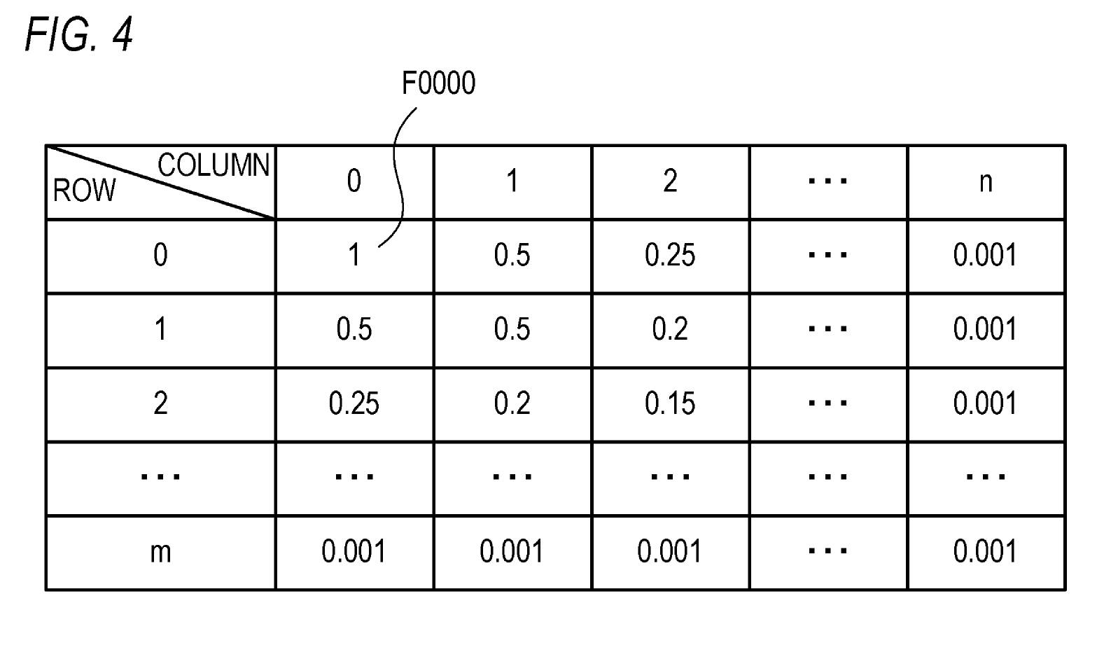

FIG. 4 shows one example of brightness change information F00 representing the diffusion of light from the light source corresponding to the divided area in the 0th row and the 0th column. Brightness F0000 in the divided area in the 0th row and the 0th column is 1. Since light from the light source corresponding to the divided area in the 0th row and the 0th column darkens as the distance increases from the divided area in the 0th row and the 0th column, brightness F00m′n′ decreases as the distance increases from the divided area in the 0th row and the 0th column.

The brightness change information F is not limited to the information (table) described above. A function may be prepared as the brightness change information F. The brightness change information F that is shared by the divided areas may be prepared.

The brightness Fmnm′n′ may not be a relative value. The brightness Fmnm′n′ may be an absolute value. The relative value can be calculated from the brightness Fmnm′n′ that is an absolute value.

The brightness change information may be or may not be information prepared in advance by a manufacturer. For example, the brightness change information may be information generated (created) by a user or display apparatus.

(Color Change Information Storage Unit)

The color change information storage unit 107 is a first storage unit that stores color change information G. The color change information G is information showing a change in color of light from the light source in the in-plane direction. In this embodiment, first color change information GX and second color change information GZ are prepared as the color change information G.

The first color change information GX shows a change in X value in the XYZ tristimulus values of light from the light source in the in-plane direction. For example, the first color change information GX is information representing the X value of light from the light source in each divided area. In this embodiment, a table representing, for each divided area, the X values, in the respective divided areas, of light from the light source corresponding to the divided area as the first color change information GX corresponding to the divided area is prepared. In this embodiment, the first color change information GX corresponding to the divided area in the m-th row and the n-th column is referred to as “first color change information GXmn”. The X value represented by the first color change information GXmn (X value, in the divided area in the m′-th row and the n′-th column, of light from the light source corresponding to the divided area in the m-th row and the n-th column) is referred to as “X value GXmnm′n′”. In this embodiment, the X value GXmnm′n′ is a relative value for the X value that is 1 when m=m′ and n=n′. That is, the X value GXmnm′n′ is a normalized X value that is the X value normalized to have a maximum value of 1.

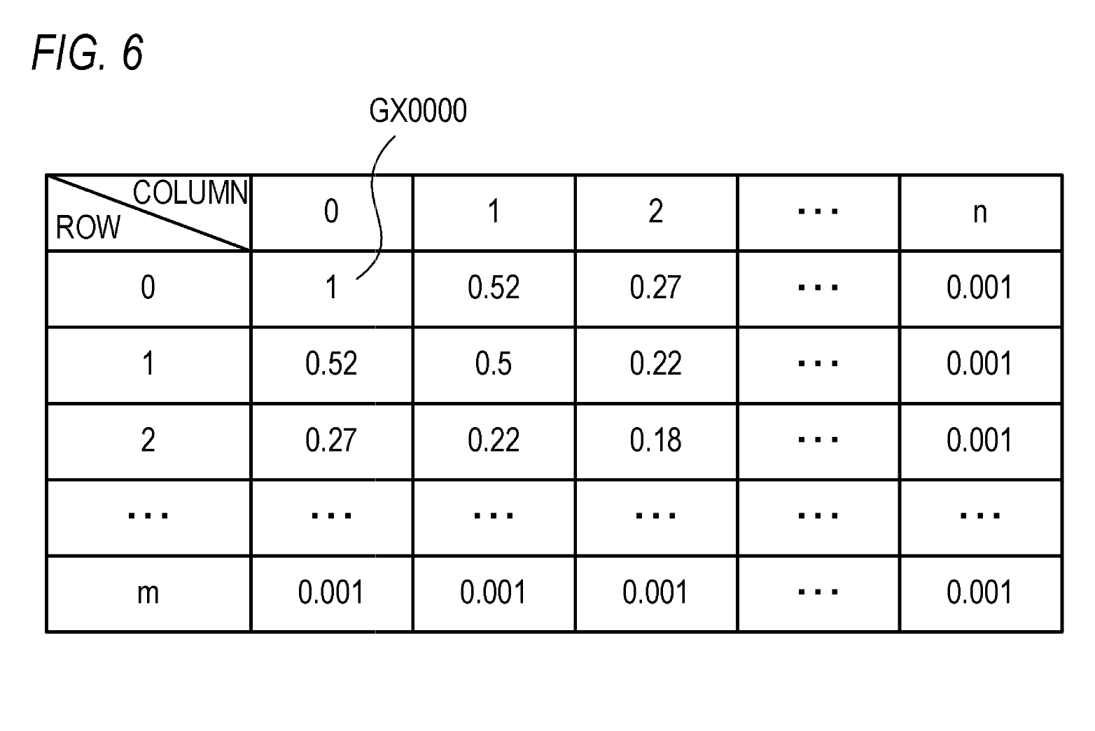

FIG. 6 shows one example of first color change information GX00 representing the diffusion of light from the light source corresponding to the divided area in the 0th row and the 0th column. An X value GX0000 in the divided area in the 0th row and the 0th column is 1. Since light from the light source corresponding to the divided area in the 0th row and the 0th column darkens as the distance increases from the divided area in the 0th row and the 0th column, an X value GX00m′n′ decreases as the distance increases from the divided area in the 0th row and the 0th column.

The second color change information GZ shows a change in Z value in the XYZ tristimulus values of light from the light source in the in-plane direction. For example, the second color change information GZ is information representing the Z value of light from the light source in each divided area. In this embodiment, a table representing, for each divided area, the Z values, in the respective divided areas, of light from the light source corresponding to the divided area as the second color change information GZ corresponding to the divided area is prepared. In this embodiment, the second color change information GZ corresponding to the divided area in the m-th row and the n-th column is referred to as “second color change information GZmn”. The Z value represented by the second color change information GZmn (Z value, in the divided area in the m′-th row and the n′-th column, of light from the light source corresponding to the divided area in the m-th row and the n-th column) is referred to as “Z value GZmnm′n′”. In this embodiment, the Z value GZmnm′n′ is a relative value for the Z value that is 1 when m=m′ and n=n′. That is, the Z value GZmnm′n′ is a normalized Z value that is the Z value normalized to have a maximum value of 1.

The color change information G is not limited to the information described above. A function may be prepared as the color change information G. The color change information G that is shared by the divided areas may be prepared. Only one of the first color change information and the second color change information may be prepared. The color change information G may be information showing a change in xy chromaticity coordinate values of light from the light source in the in-plane direction. The color change information G may be information showing a change in uv chromaticity coordinate values of light from the light source in the in-plane direction. The color change information G may be information showing a change in u′v′ chromaticity coordinate values of light from the light source in the in-plane direction. The color change information G may be information showing a change in a*b* chromaticity coordinate values of light from the light source in the in-plane direction.

The X value GXmnm′n′ may not be a relative value. The X value GXmnm′n′ may be an absolute value. The relative value can be calculated from the X value GXmnm′n′ that is an absolute value. It is similar for the Z value GZmnm′n′.

The color change information may be or may not be information prepared in advance by a manufacturer. For example, the color change information may be information generated (created) by a user or display apparatus.

In this embodiment, color correction processing is performed for each divided area. In this embodiment, a divided area that is a target of the color correction processing is referred to as “second target area”. In this embodiment, image color correction processing of correcting the color of each pixel of image data in the second target area is performed as the color correction processing, based on the emission brightness of each light source determined by the BL control value determination unit 103, the color change information G, and the brightness change information F. The color correction processing reduces a change in display color in the second target area due to leakage of light from the light source corresponding to the divided area other than the second target area to the second target area.

In this embodiment, brightness correction processing is also performed. In the brightness correction processing, the brightness of each pixel of image data is corrected, based on the emission brightness of each light source determined by the BL control value determination unit 103 and the brightness change information F. The brightness correction processing reduces a change in display brightness due to leakage of light from the light source to other divided areas.

The BL control value determination unit 103 may determine the emission brightness of each light source separately, based on input image data and the brightness change information F, so as to reduce a change in display brightness due to leakage of light from the light source to other divided areas. The brightness correction processing described above may not be performed, in the case where emission brightness in which a change in display brightness due to leakage of source light has been sufficiently reduced is obtained as the emission brightness of each light source. A change in display brightness due to leakage of the source light may not be reduced, in the case where the change in display brightness due to leakage of source light is tolerated.

(BL Brightness Calculation Unit)

For each divided area, the BL brightness calculation unit 105 calculates a corresponding brightness T (in corresponding brightness calculation processing), based on the BL control value bd of each light source output from the BL control value determination unit 103 and the brightness change information F. In this embodiment, the corresponding brightness T of the divided area in the m-th row and the n-th column is referred to as “corresponding brightness Tmn”. The corresponding brightness Tmn is the emission brightness of the backlight 102 in the divided area in the m-th row and the n-th column, in a state where each light source emits light with the BL control value bd output from the BL control value determination unit 103. The BL brightness calculation unit 105 outputs the corresponding brightness T of each divided area to the brightness correction value calculation unit 106 and the color correction value calculation unit 109.

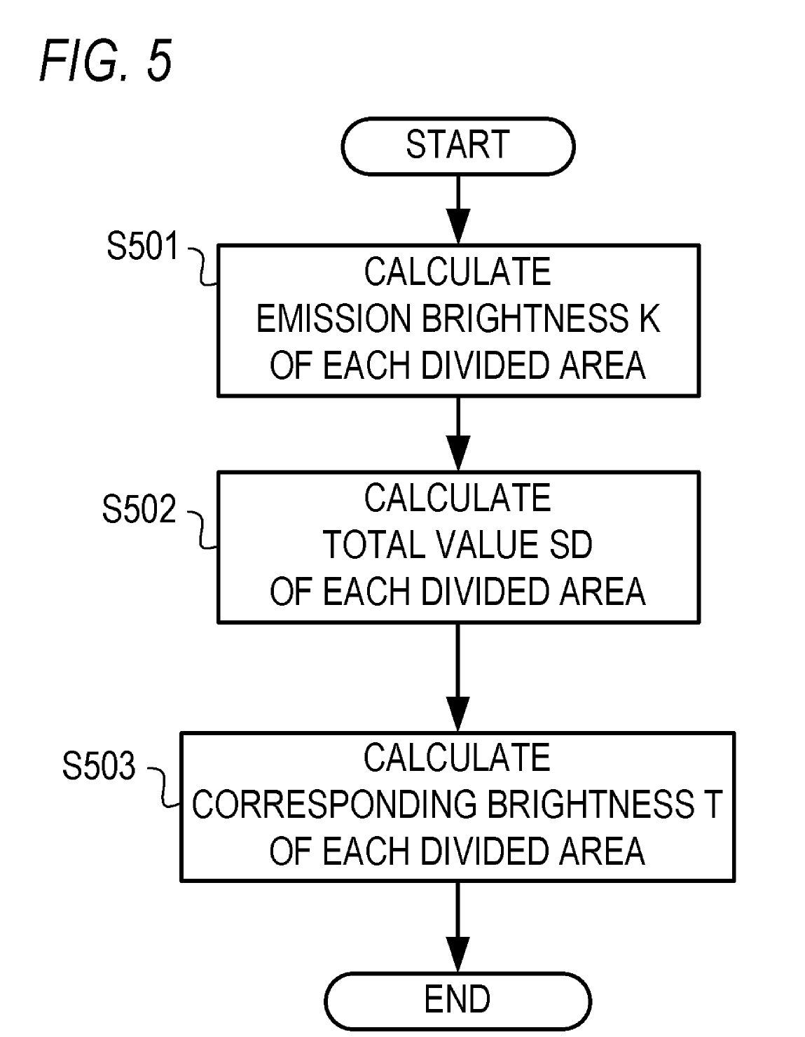

A method of calculating the corresponding brightness T will be described using a flowchart in FIG. 5. FIG. 5 is a flowchart showing one example of the corresponding brightness calculation processing.

First, for each divided area, the BL brightness calculation unit 105 calculates emission brightness K of the backlight 102 in each divided area in the case where only the light source corresponding to the divided area emits light with the BL control value bd (S501). In this embodiment, the brightness K, in the divided area in the m′-th row and the n′-th column, of light emitted from the light source corresponding to the divided area in the m-th row and the n-th column is referred to as “brightness Kmnm′n′”. The brightness Kmnm′n′ is calculated using the following expression 3.

Kmnm′n′=Fmnm′n′×BDmn (Expression 3)

In expression 3, “BDmn” is the emission brightness of the backlight 102 in the divided area in the m-th row and the n-th column in the case where only the light source corresponding to the divided area in the m-th row and the n-th column emits light with the BL control value bdmn. It can also be said that the brightness BDmn is the “emission brightness of the light source corresponding to the divided area in the m-th row and the n-th column”. For example, the correspondence relationship of the BL control value bdmn and the brightness BDmn is prepared in advance, and the brightness BDmn is calculated from the BL control value bdmn. The brightness YAGmn or the BL control value bdmn may be used as the brightness BDmn.

Next, for each divided area, the BL brightness calculation unit 105 calculates a total value SD of the brightness of light from other divided areas (S502), using the brightness K calculated in S501. In this embodiment, the total value SD for the divided area in the m-th row and the n-th column is referred to as “total value SDmn”. The total value SDmn is calculated using the following expression 4.

$$\begin{matrix}[ Formula 1 ] & \\ SDmn = {\sum }_{\{ {m}^{′} , {n}^{′} : {m}^{′} \neq m ⋁ {n}^{′} \neq n \}} {Km}^{′} {n}^{′} mn & ( Expression 4 )\end{matrix}$$

The BL brightness calculation unit 105 calculates the corresponding brightness T of each divided area (S503), using the brightness K calculated in S501 and the total value SD calculated in S502. The corresponding brightness Tmn is calculated using the following expression 5. The brightness BDmn may be used instead of brightness Kmnmn.

Tmn=Kmnmn+SDmn (Expression 5)

(BL Color Calculation Unit)

For each divided area, the BL color calculation unit 108 calculates a corresponding color C (in corresponding color calculation processing), based on the BL control value bd of each light source output from the BL control value determination unit 103 and the color change information G. In this embodiment, a corresponding X value CX that is the X value of the corresponding color C and a corresponding Z value CZ that is the Z value of the corresponding color C are calculated as the corresponding color C. In this embodiment, the corresponding X value CX of the divided area in the m-th row and the n-th column is referred to as “corresponding X value CXmn”, and the corresponding Z value CZ of the divided area in the m-th row and the n-th column is referred to as “corresponding Z value CZmn”. A corresponding color Cmn is the emission color of the backlight 102 in the divided area in the m-th row and the n-th column, in a state where each light source emits light with the BL control value bd output from the BL control value determination unit 103. The corresponding X value CXmn is the X value of light of the backlight in the divided area in the m-th row and the n-th column, in a state where each light source emits light with the BL control value bd output from the BL control value determination unit 103. The corresponding Z value CZmn is the Z value of light of the backlight in the divided area in the m-th row and the n-th column, in a state where each light source emits light with the BL control value bd output from the BL control value determination unit 103. The light of the backlight is light emitted from the backlight 102 (combined light in which light emitted from the respective light sources is combined). The BL color calculation unit 108 outputs the corresponding color C (the corresponding X value CX and the corresponding Z value CZ) of each divided area to the color correction value calculation unit 109.

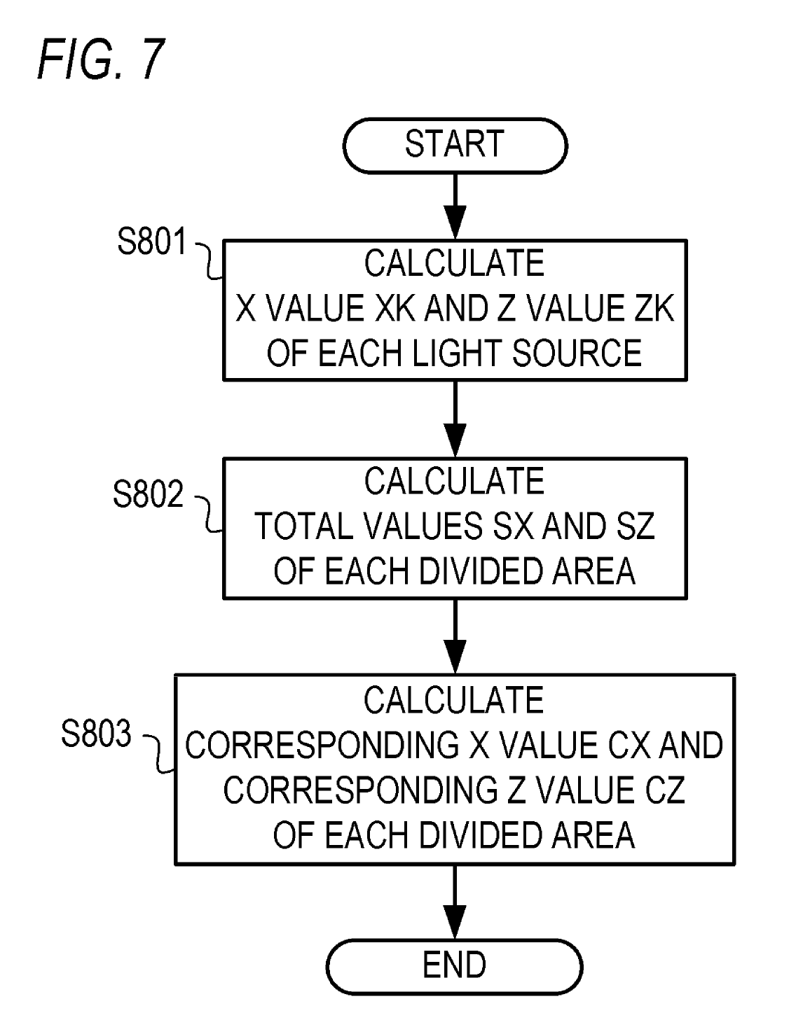

A method of calculating the corresponding color C will be described using a flowchart in FIG. 7. FIG. 7 is a flowchart showing one example of the corresponding color calculation processing.

First, for each light source, the BL color calculation unit 108 calculates an X value XK and a Z value ZK of light of the backlight in each divided area in the case where only that light source emits light with the BL control value bd (S801). In this embodiment, the X value XK, in the divided area in the m′-th row and the n′-th column, of light emitted from the light source corresponding to the divided area in the m-th row and the n-th column is referred to as “X value XKmnm′n′”. The Z value ZK, in the divided area in the m′-th row and the n′-th column, of light emitted from the light source corresponding to the divided area in the m-th row and the n-th column is referred to as “Z value ZKmnm′n′”. The X value XKmnm′n′ is calculated using the following expression 6, and the Z value ZKmnm′n′ is calculated using the following expression 7. As shown in expression 6, the X value XKmnm′n′ is a weighted X value obtained by multiplying the normalized X value GXmnm′n′ of light emitted from the light source corresponding to the divided area in the m-th row and the n-th column, by the emission brightness BDmn. As shown in expression 7, the Z value ZKmnm′n′ is a weighted Z value obtained by multiplying the normalized Z value GZmnm′n′ of light emitted from the light source corresponding to the divided area in the m-th row and the n-th column, by the emission brightness BDmn.

XKmnm′n′=GXmnm′n′×BDmn (Expression 6)

ZKmnm′n′=GZmnm′n′×BDmn (Expression 7)

Next, for each divided area, the BL color calculation unit 108 calculates a total value SX of the X values of light from other divided areas (S802), using the X value XK calculated in S801. For each divided area, the BL color calculation unit 108 calculates a total value SZ of the Z values of light from other divided areas, using the Z value ZK calculated in S801. In this embodiment, the total value SX for the divided area in the m-th row and the n-th column is referred to as “total value SXmn”, and the total value SZ for the divided area in the m-th row and the n-th column is referred to as “total value SZmn”. The total value SXmn is calculated using the following expression 8, and the total value SZmn is calculated using the following expression 9.

$$\begin{matrix}[ Formula 2 ] & \\ SXmn = {\sum }_{\{ {m}^{′} , {n}^{′} : {m}^{′} \neq m ⋁ {n}^{′} \neq n \}} {XKm}^{′} {n}^{′} mn & ( Expression 8 ) \\ SZmn = {\sum }_{\{ {m}^{′} , {n}^{′} : {m}^{′} \neq m ⋁ {n}^{′} \neq n \}} {ZKm}^{′} {n}^{′} mn & ( Expression 9 )\end{matrix}$$

The BL color calculation unit 108 calculates the corresponding X value CX of each divided area (S803), using the X value XK calculated in S801 and the total value SX calculated in S802. The BL color calculation unit 108 calculates the corresponding Z value CZ of each divided area, using the Z value ZK calculated in S801 and the total value SZ calculated in S802. The corresponding X value CXmn is calculated using the following expression 10, and the corresponding Z value CZmn is calculated using the following expression 11. As is clear from expressions 8 and 10, the corresponding X value CXmn is the sum (first total value) of X values XKm′n′mn, in the divided area in the m-th row and the n-th column, of light from all of the divided areas. As is clear from expressions 9 and 11, the corresponding Z value CZmn is the sum (second total value) of Z values ZKm′n′mn, in the divided area in the m-th row and the n-th column, of light from all of the divided areas.

CXmn=XKmnmn+SXmn (Expression 10)

CZmn=ZKmnmn+SZmn (Expression 11)

(Brightness Correction Value Calculation Unit)

The brightness correction value calculation unit 106 calculates a brightness correction value that is a correction value used in the brightness correction processing, based on the corresponding brightness T of each divided area output from the BL brightness calculation unit 105. In this embodiment, the brightness correction value for correction of each pixel value of input image data in the divided area is calculated for each divided area. In this embodiment, a brightness correction coefficient U by which the pixel value is to be multiplied is calculated as the brightness correction value. In this embodiment, the brightness correction coefficient U of the divided area in the m-th row and the n-th column is referred to as “brightness correction coefficient Umn”. The brightness correction value calculation unit 106 outputs the brightness correction coefficient U of each divided area to the brightness correction unit 110.

In this embodiment, the brightness correction coefficient Umn is calculated using the following expression 12. In expression 12, “BLYt” is a reference value (reference Y value) for the Y value in the XYZ tristimulus values. It can also be said that the reference Y value BLYt is “the reference value for the brightness of light of the backlight”. The reference Y value BLYt is the brightness of light of the backlight when a non-local-dimming mode that is an operation mode for causing the respective light sources to emit light with the same emission brightness is set, for example. According to expression 12, the brightness correction coefficient Umn that increases the brightness of a pixel is calculated in the case where the brightness Tmn is lower than the reference Y value BLYt, and the brightness correction coefficient Umn that reduces the brightness of a pixel is calculated in the case where the brightness Tmn is higher than the reference Y value BLYt.

Umn=BLYt÷Tmn (Expression 12)

The reference Y value BLYt may be prepared for each divided area, or one reference Y value BLYt shared by a plurality of divided areas may be prepared.

A method of calculating the brightness correction value is not limited to the method described above. For example, an additional value to be added to the pixel value may be calculated as the brightness correction value. For each pixel, the corresponding brightness in the position of the pixel may be calculated, based on the BL control value bd of each light source and the brightness change information F. For each pixel, the brightness correction value of the pixel may be calculated, based on the corresponding brightness of the pixel.

(Brightness Correction Unit)

The brightness correction unit 110 corrects input image data (in the brightness correction processing), using the brightness correction coefficient U of each divided area output from the brightness correction value calculation unit 106. Specifically, for each divided area, each pixel value of the input image data in the divided area is multiplied by the brightness correction coefficient U of the divided area. Accordingly, first corrected image data that is image data after performing the brightness correction processing is generated. The brightness correction unit 110 outputs the first corrected image data to the color correction unit 111.

(Color Correction Value Calculation Unit)

The color correction value calculation unit 109 acquires the corresponding brightness T of each divided area output from the BL brightness calculation unit 105 and the corresponding color C of each divided area output from the BL color calculation unit 108. The color correction value calculation unit 109 calculates a color correction value that is a correction value used in the color correction processing, based on the corresponding brightness T and the corresponding color C of each divided area. In this embodiment, the color correction value for correction of the color (pixel color) of each pixel of the first corrected image data in the divided area is calculated for each divided area. In this embodiment, a color correction coefficient V by which the value of the pixel color is to be multiplied is calculated as the color correction value. Specifically, a first correction coefficient VX for correction of the X value of the pixel color and a second correction coefficient VZ by which the Z value of the pixel color is to be multiplied are calculated as the color correction coefficient V. In this embodiment, the first correction coefficient VX of the divided area in the m-th row and the n-th column is referred to as “first correction coefficient VXmn”, and the second correction coefficient VZ of the divided area in the m-th row and the n-th column is referred to as “second correction coefficient VZmn”. The brightness correction value calculation unit 106 outputs the first correction coefficient VX and the second correction coefficient VZ of each divided area to the color correction unit 111.

In this embodiment, the first correction coefficient VXmn is calculated using the following expression 13, and the second correction coefficient VZmn is calculated using the following expression 14. In expressions 13 and 14, “BLXt” is a reference value (reference X value) for the X value in the XYZ tristimulus values, and “BLZt” is a reference value (reference Z value) for the Z value in the XYZ tristimulus values. It can also be said that the reference X value BLXt is “the reference value for the X value of light of the backlight”, and it can also be said that the reference Z value BLZt is “the reference value for the Z value of light of the backlight”. For example, the reference X value BLXt is the X value of light of the backlight when the non-local-dimming mode is set, and the reference Z value BLZt is the Z value of light of the backlight when the non-local-dimming mode is set.

VXmn=(BLXt÷BLYt)÷(CXmn÷Tmn) (Expression 13)

VZmn=(BLZt÷BLYt)÷(CZmn÷Tmn) (Expression 14)

In this manner, in this embodiment, the first correction coefficient VX is calculated by dividing the ratio of the reference X value BLXt to the reference Y value BLYt by the ratio of the corresponding X value CX to the corresponding brightness T. The second correction coefficient VZ is calculated by dividing the ratio of the reference Z value BLZt to the reference Y value BLYt by the ratio of the corresponding Z value CZ to the corresponding brightness T.

Consider a case where the corresponding brightness Tmn is equal to the reference Y value BLYt. According to expression 13, the first correction coefficient VXmn that increases the X value of the pixel color is calculated in the case where the corresponding X value CX is lower than the reference X value BLXt, and the first correction coefficient VXmn that reduces the X value of the pixel color is calculated in the case where the corresponding X value CX is higher than the reference X value BLXt. According to expression 14, the second correction coefficient VZmn that increases the Z value of the pixel color is calculated in the case where the corresponding Z value CZ is lower than the reference Z value BLZt, and the second correction coefficient VZmn that reduces the Z value of the pixel color is calculated in the case where the corresponding Z value CZ is higher than the reference Z value BLZt.

The reference X value BLXt may be prepared for each divided area, or one reference X value BLXt shared by a plurality of divided areas may be prepared. It is similar for the reference Z value BLZt.

A method of calculating the color correction value is not limited to the method described above. For example, an additional value to be added to the value of the display color may be calculated as the color correction value. For each pixel, the corresponding brightness in the position of the pixel may be calculated, based on the BL control value bd of each light source and the brightness change information F. For each pixel, the corresponding color in the position of the pixel may be calculated, based on the BL control value bd of each light source and the color change information G. For each pixel, the color correction value of the pixel may be calculated, based on the corresponding brightness and the corresponding color of the pixel.

(Color Correction Unit)

The color correction unit 111 corrects the first corrected image data (in the color correction processing) output from the brightness correction unit 110, using the color correction coefficient (the first correction coefficient VX and the second correction coefficient VZ) of each divided area output from the color correction value calculation unit 109. Specifically, each pixel value of the first corrected image data in the second target area is corrected, so as to correct the X value of the pixel color of the first corrected image data in the second target area to a value obtained by multiplying the X value by the first correction coefficient VX of the second target area. Accordingly, the X value of the display color in the second target area is corrected to the value obtained by multiplying the X value by the first correction coefficient VX of the second target area. Each pixel value of the first corrected image data in the second target area is corrected, so as to correct the Z value of the pixel color of the first corrected image data in the second target area to a value obtained by multiplying the Z value by the second correction coefficient VZ of the second target area. Accordingly, the Z value of the display color in the second target area is corrected to the value obtained by multiplying the Z value by the second correction coefficient VZ of the second target area. The processing described above is repeated while selecting the plurality of divided areas in order as the second target area. Accordingly, second corrected image data that is image data after performing the brightness correction processing and the color correction processing is generated. In the color correction processing, the pixel color is corrected to maintain the brightness of the pixel. The color correction unit 111 outputs the second corrected image data to the liquid crystal panel 101.

The color correction processing may be performed after the brightness correction processing. Image processing that realizes both the color correction processing and the brightness correction processing may be performed.

With this embodiment, as described above, the color correction processing of correcting the color of each pixel of input image data is performed, based on the emission brightness of each light source, the color change information, and the brightness change information. Accordingly, a change in display color due to leakage of light emitted from the light source to other divided areas can be prevented.

A method of the color correction processing or the brightness correction processing is not limited to the method described above. The color correction processing may be any processing that can prevent a change in display color due to leakage of light emitted from the light source to other divided areas. The brightness correction processing may be any processing that can prevent a change in display brightness due to leakage of light emitted from the light source to other divided areas.

### Embodiment 2

A display apparatus and a method of controlling the same according to Embodiment 2 of the present invention will be described below. In this embodiment, an example having a configuration capable of changing the emission color of a light source will be described.

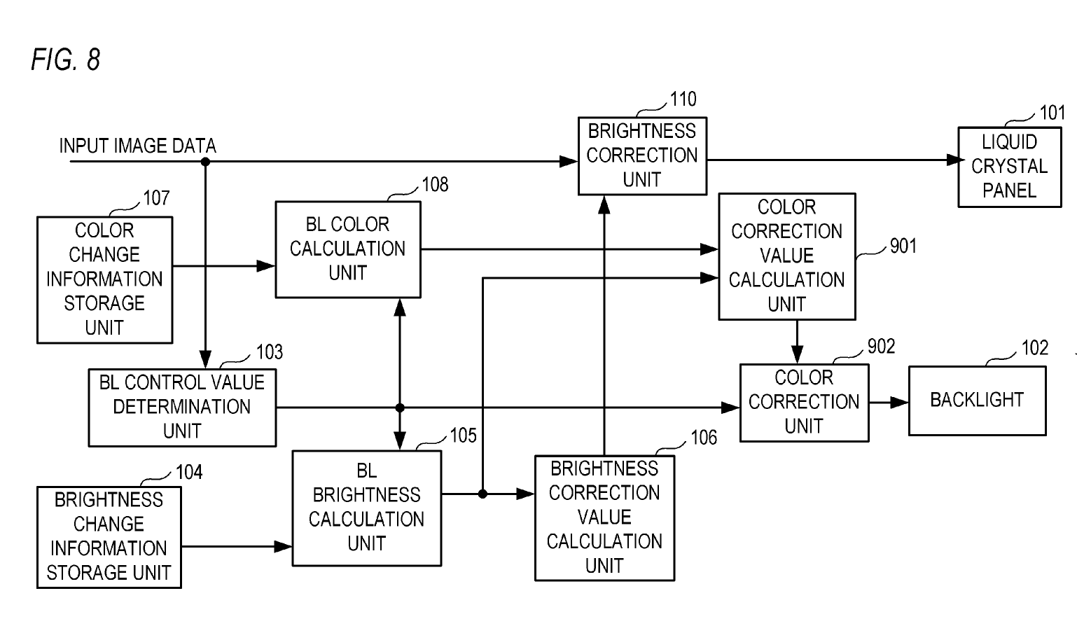

FIG. 8 is a block diagram showing one example of the configuration of the display apparatus according this embodiment. In FIG. 8, the same functional units as in Embodiment 1 are denoted by the same reference numerals as in Embodiment 1, and description is omitted. In this embodiment, as shown in FIG. 8, first corrected image data output from the brightness correction unit 110 is input to the liquid crystal panel 101. In this embodiment, processing of correcting the emission color of the light source is performed as color correction processing.

In this embodiment, the light source of the backlight 102 has a plurality of colored light-emitting elements of which the emission colors differ from each other. Specifically, the light source has three (three types of) colored light-emitting elements, i.e., an R element of which the emission color is red, a G element of which the emission color is green, and a B element of which the emission color is blue.

The types of light-emitting elements of the light source are not limited to the three types described above. For example, the light source may have a Ye element of which the emission color is yellow.

The number of the light-emitting elements of the light source may be more or less than three. The number of the light-emitting elements of the light source may be one. In the case where the number of the light-emitting elements of the light source is one, the light-emitting element of the light source may be a white element of which the emission color is white. The configuration of the light source may be any configuration capable of changing the emission color. For example, the configuration of the light source may be a configuration capable of changing the emission color of one light-emitting element, using a plurality of color filters.

In this embodiment, the BL control value determination unit 103 determines a BL control value of the three colored light-emitting elements of the light source, so as to realize the emission brightness based on input image data as the emission brightness of the light source. Herein, “the emission brightness of the light source” indicates “a brightness of combined light in which light emitted from the three colored light-emitting elements of the light source is combined”, “a combined value of the emission brightness of the three colored light-emitting elements of the light source”, or the like. The BL control value determination unit 103 outputs each determined BL control value to a color correction unit 902, the BL brightness calculation unit 105, and the BL color calculation unit 108. In this embodiment, the BL control value of the R element is referred to as “BL control value bd_r”, the BL control value of the G element is referred to as “BL control value bd_g”, and the BL control value of the B element is referred to as “BL control value bd_b”.

(Color Correction Value Calculation Unit)

A color correction value calculation unit 901 calculates a color correction value, based on the corresponding brightness T of each divided area output from the BL brightness calculation unit 105 and the corresponding color C of each divided area output from the BL color calculation unit 108. In this embodiment, the color correction value for correction of the emission color of the light source corresponding to the divided area is calculated for each divided area. Specifically, in a similar manner to Embodiment 1, the first correction coefficient VX and the second correction coefficient VZ are calculated.

Further, for each divided area, the color correction value calculation unit 901 transforms the first correction coefficient VX and the second correction coefficient VZ of the divided area to an R correction coefficient WR, a G correction coefficient WG, and a B correction coefficient WB, using a transformation matrix for trans forming XYZ tristimulus values to RGB values. The R correction coefficient WR is a correction value for correction of the emission brightness of the R element and is a correction coefficient by which the BL control value bd_r is to be multiplied. The G correction coefficient WG is a correction value for correction of the emission brightness of the G element and is a correction coefficient by which the BL control value bd_g is to be multiplied. The B correction coefficient WB is a correction value for correction of the emission brightness of the B element and is a correction coefficient by which the BL control value bd_b is to be multiplied. The color correction value calculation unit 901 outputs the R correction coefficient WR, the G correction coefficient WG, and the B correction coefficient WB of each divided area to the color correction unit 902. In this embodiment, the R correction coefficient WR of the R element corresponding to the divided area in the m-th row and the n-th column is referred to as “R correction coefficient WRmn”. The G correction coefficient WG of the G element corresponding to the divided area in the m-th row and the n-th column is referred to as “G correction coefficient WGmn”. The B correction coefficient WB of the B element corresponding to the divided area in the m-th row and the n-th column is referred to as “B correction coefficient WBmn”.

In this embodiment, the R correction coefficient WRmn, the G correction coefficient WGmn, and the B correction coefficient WBmn are calculated using the following expression 15. In expression 15, a matrix with three rows and three columns including nine matrix coefficients aX, aY, aZ, bX, bY, bZ, cX, cY, and cZ is the transformation matrix described above.

$$\begin{matrix}[ Formula 3 ] & \\ ( \begin{matrix}WRmn \\ WGmn \\ WBmn\end{matrix} ) = ( \begin{matrix}aX & aY & aZ \\ bX & bY & bZ \\ cX & cY & cZ\end{matrix} ) ( \begin{matrix}VXmn \\ 1 \\ VZmn\end{matrix} ) & ( Expression 15 )\end{matrix}$$

The correction value for correction of the emission brightness of the R element is not limited to the R correction coefficient WR. For example, an additional value to be added to the BL control value bd_r may be calculated as the correction value for correction of the emission brightness of the R element. It is similar for the correction value for correction of the emission brightness of the G element and the correction value for correction of the emission brightness of the B element.

(Color Correction Unit)

The color correction unit 902 corrects the BL control value (in the color correction processing) output from the BL control value determination unit 103, using the R correction coefficient WR, the G correction coefficient WG, and the B correction coefficient WB output from the color correction value calculation unit 109. Specifically, the BL control value bd_r in a second target area is multiplied by the R correction coefficient WR of the second target area, the BL control value bd_g of the second target area is multiplied by the G correction coefficient WG of the second target area, and the BL control value bd_b of the second target area is multiplied by the B correction coefficient WB of the second target area. Accordingly, the emission brightness of each colored light-emitting element of the light source corresponding to the second target area is corrected, and the emission color of the light source corresponding to the second target area is corrected. Specifically, the X value of the emission color of the light source corresponding to the second target area is corrected to a value obtained by multiplying the X value by the first correction coefficient VX of the second target area. As a result, the X value of the display color in the second target area is corrected to the value obtained by multiplying the X value by the first correction coefficient VX of the second target area. The Z value of the emission color of the light source corresponding to the second target area is corrected to a value obtained by multiplying the Z value by the second correction coefficient VZ of the second target area. As a result, the Z value of the display color in the second target area is corrected to the value obtained by multiplying the Z value by the second correction coefficient VZ of the second target area. The processing described above is repeated while selecting the plurality of divided areas in order as the second target area.

The color correction unit 902 outputs each BL control value after the color correction processing to the backlight 102. As a result, each light-emitting element of the backlight 102 emits light with the emission brightness in accordance with the BL control value after the color correction processing.

A method of the color correction processing is not limited to the method described above. For example, the emission color of the light source may be corrected, based on the first correction coefficient VX and the second correction coefficient VZ, without calculating the R correction coefficient WR, the G correction coefficient WG, and the B correction coefficient WB.

With this embodiment, as described above, the color correction processing of correcting the emission color of each light source is performed, based on the emission brightness of each light source, color change information, and brightness change information. Accordingly, a change in display color due to leakage of light emitted from the light source to other divided areas can be prevented.

Performing processing of correcting the color of each pixel of image data as the color correction processing poses a risk of reducing the dynamic range or color gamut of the display brightness. In this embodiment, a decrease in the dynamic range or color gamut of the display brightness can be prevented, since the color of the pixel of image data is not corrected in the color correction processing.

The example of the color correction processing of correcting the color of image data has been described in Embodiment 1, and the example of the color correction processing of correcting the emission color of the light source has been described in Embodiment 2. However, these are not limiting. Processing of correcting both the color of image data and the emission color of the light source may be performed as the color correction processing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-008465, filed on Jan. 20, 2015, which is hereby incorporated by reference herein in its entirety.

What is claimed is:

1. A display apparatus comprising:
a light-emitter configured to have a plurality of light sources corresponding to a plurality of divided areas forming an area of a screen;
a display unit configured to display an image on the screen by transmission of light from the light-emitter with a transmittance based on input image data;
a determining unit configured to determine emission brightness of each light source separately, based on the input image data;
a first storage configured to store color change information showing a change in color of light from the light source in an in-plane direction of the screen; and
a color corrector configured to perform color correction processing of correcting at least one of a color of each pixel of image data in a target area, and an emission color of the light source corresponding to the target area, based on the color change information.

2. The display apparatus according to claim 1, further comprising a second storage configured to store brightness change information showing a change in brightness of light from the light source in the in-plane direction, wherein
the color corrector performs, for each divided area, the color correction processing, and
the color correction processing is processing of correcting at least one of a color of each pixel of image data in the target area that is the divided area, and an emission color of the light source corresponding to the target area, based on the emission brightness of each light source determined by the determining unit, the color change information, and the brightness change information, so as to reduce a change in display color of the target area due to leakage of light from the light source corresponding to a divided area other than the target area to the target area.

3. The display apparatus according to claim 2, wherein the determining unit determines the emission brightness of each light source separately, based on the input image data and the brightness change information, so as to reduce a change in display brightness due to leakage of light from the light source to another divided area.

4. The display apparatus according to claim 2, further comprising a brightness corrector configured to correct brightness of each pixel of the image data, based on the emission brightness of each light source determined by the determining unit and the brightness change information, so as to reduce a change in display brightness due to leakage of light from the light source to another divided area.

5. The display apparatus according to claim 2, wherein the color change information includes at least one of first color change information showing a change in X value in XYZ tristimulus values of light from the light source in the in-plane direction and second color change information showing a change in Z value in the XYZ tristimulus values of light from the light source in the in-plane direction.

6. The display apparatus according to claim 5,
wherein the first color change information is information showing a change, in the in-plane direction, in normalized X value that is the X value normalized to have a maximum value of 1, and
in the color correction processing,
a weighted X value is calculated for each light source by multiplying the normalized X value, in the target area, of light emitted from the light source, by the emission brightness of the light source determined by the determining unit,
a first total value that is a sum of the weighted X values of the respective light sources is calculated,
corresponding brightness, which is emission brightness calculated based on the brightness change information and is emission brightness of the light-emitter in the target area in a state where each light source emits light with the emission brightness determined by the determining unit, is acquired,
a first correction coefficient is calculated by dividing a ratio of a reference value for the X value to a reference value for a Y value in the XYZ tristimulus values, by a ratio of the first total value to the corresponding brightness, and
at least one of the color of each pixel of the image data in the target area and the emission color of the light source corresponding to the target area is corrected, so as to correct an X value of the display color of the target area to a value obtained by multiplying the X value by the first correction coefficient.

7. The display apparatus according to claim 5,
wherein the second color change information is information showing a change, in the in-plane direction, in normalized Z value that is the Z value normalized to have a maximum value of 1, and
in the color correction processing,
a weighted Z value is calculated for each light source by multiplying the normalized Z value, in the target area, of light emitted from the light source, by the emission brightness of the light source determined by the determining unit,
a second total value that is a sum of the weighted Z values of the respective light sources is calculated,
corresponding brightness, which is emission brightness calculated based on the brightness change information and is emission brightness of the light-emitter in the target area in a state where each light source emits light with the emission brightness determined by the determining unit, is acquired,
a second correction coefficient is calculated by dividing a ratio of a reference value for the Z value to a reference value for a Y value in the XYZ tristimulus values, by a ratio of the second total value to the corresponding brightness, and
at least one of the color of each pixel of the image data in the target area and the emission color of the light source corresponding to the target area is corrected, so as to correct a Z value of the display color of the target area to a value obtained by multiplying the Z value by the second correction coefficient.

8. The display apparatus according to claim 1, wherein the color change information shows a change in xy chromaticity coordinate values of light from the light source in the in-plane direction, a change in uv chromaticity coordinate values of light from the light source in the in-plane direction, a change in u′v′ chromaticity coordinate values of light from the light source in the in-plane direction, or a change in a*b* chromaticity coordinate values of light from the light source in the in-plane direction.

9. The display apparatus according to claim 1,
wherein an emission color of the light source is white, and
the color correction processing is processing of correcting the color of each pixel of the image data in the target area.

10. The display apparatus according to claim 1,
wherein the light source has a plurality of colored light-emitting elements of which emission colors differ from each other, and
the color correction processing includes processing of correcting the emission color of the light source corresponding to the target area by correcting emission brightness of each colored light-emitting element of the light source corresponding to the target area.

11. The display apparatus according to claim 2, wherein the brightness change information shows a change in Y value in XYZ tristimulus values of light from the light source in the in-plane direction.

12. A method for controlling a display apparatus having:
a light-emitter configured to have a plurality of light sources corresponding to a plurality of divided areas forming an area of a screen;
a display unit configured to display an image on the screen by transmission of light from the light-emitter with a transmittance based on input image data; and
a first storage configured to store color change information showing a change in color of light from the light source in an in-plane direction of the screen,
the method comprising:
a determining step of determining emission brightness of each light source separately, based on the input image data; and
a color correcting step of performing color correction processing of correcting at least one of a color of each pixel of image data in a target area, and an emission color of the light source corresponding to the target area, based on the color change information.

13. The method according to claim 12, wherein
the display apparatus has a second storage configured to store brightness change information showing a change in brightness of light from the light source in the in-plane direction, and
in the color correcting step, for each divided area, the color correction processing is performed, and
the color correction processing is processing of correcting at least one of a color of each pixel of image data in the target area that is the divided area, and an emission color of the light source corresponding to the target area, based on the emission brightness of each light source determined in the determining step, the color change information, and the brightness change information, so as to reduce a change in display color of the target area due to leakage of light from the light source corresponding to a divided area other than the target area to the target area.

14. The method according to claim 13, wherein in the determining step, the emission brightness of each light source is determined separately, based on the input image data and the brightness change information, so as to reduce a change in display brightness due to leakage of light from the light source to another divided area.

15. The method according to claim 13, further comprising a brightness correcting step of correcting brightness of each pixel of the image data, based on the emission brightness of each light source determined in the determining step and the brightness change information, so as to reduce a change in display brightness due to leakage of light from the light source to another divided area.

16. The method according to claim 13, wherein the color change information includes at least one of first color change information showing a change in X value in XYZ tristimulus values of light from the light source in the in-plane direction and second color change information showing a change in Z value in the XYZ tristimulus values of light from the light source in the in-plane direction.

17. The method according to claim 16,
wherein the first color change information is information showing a change, in the in-plane direction, in normalized X value that is the X value normalized to have a maximum value of 1, and
in the color correction processing,
a weighted X value is calculated for each light source by multiplying the normalized X value, in the target area, of light emitted from the light source, by the emission brightness of the light source determined in the determining step,
a first total value that is a sum of the weighted X values of the respective light sources is calculated,
corresponding brightness, which is emission brightness calculated based on the brightness change information and is emission brightness of the light-emitter in the target area in a state where each light source emits light with the emission brightness determined in the determining step, is acquired,
a first correction coefficient is calculated by dividing a ratio of a reference value for the X value to a reference value for a Y value in the XYZ tristimulus values, by a ratio of the first total value to the corresponding brightness, and
at least one of the color of each pixel of the image data in the target area and the emission color of the light source corresponding to the target area is corrected, so as to correct an X value of the display color of the target area to a value obtained by multiplying the X value by the first correction coefficient.

18. The method according to claim 16,
wherein the second color change information is information showing a change, in the in-plane direction, in normalized Z value that is the Z value normalized to have a maximum value of 1, and
in the color correction processing,
a weighted Z value is calculated for each light source by multiplying the normalized Z value, in the target area, of light emitted from the light source, by the emission brightness of the light source determined in the determining step,
a second total value that is a sum of the weighted Z values of the respective light sources is calculated,
corresponding brightness, which is emission brightness calculated based on the brightness change information and is emission brightness of the light-emitter in the target area in a state where each light source emits light with the emission brightness determined in the determining step, is acquired,
a second correction coefficient is calculated by dividing a ratio of a reference value for the Z value to a reference value for a Y value in the XYZ tristimulus values, by a ratio of the second total value to the corresponding brightness, and
at least one of the color of each pixel of the image data in the target area and the emission color of the light source corresponding to the target area is corrected, so as to correct a Z value of the display color of the target area to a value obtained by multiplying the Z value by the second correction coefficient.

19. The method according to claim 12, wherein the color change information shows a change in xy chromaticity coordinate values of light from the light source in the in-plane direction, a change in uv chromaticity coordinate values of light from the light source in the in-plane direction, a change in u′v′ chromaticity coordinate values of light from the light source in the in-plane direction, or a change in a*b* chromaticity coordinate values of light from the light source in the in-plane direction.

20. The method according to claim 12,
wherein an emission color of the light source is white, and
the color correction processing is processing of correcting the color of each pixel of the image data in the target area.

21. The method according to claim 12,
wherein the light source has a plurality of colored light-emitting elements of which emission colors differ from each other, and
the color correction processing includes processing of correcting the emission color of the light source corresponding to the target area by correcting emission brightness of each colored light-emitting element of the light source corresponding to the target area.

22. The method according to claim 13, wherein the brightness change information shows a change in Y value in XYZ tristimulus values of light from the light source in the in-plane direction.

23. A non-transitory computer readable medium that stores a program, wherein the program causes a computer to execute a method for controlling a display apparatus having:
a light-emitter configured to have a plurality of light sources corresponding to a plurality of divided areas forming an area of a screen;
a display unit configured to display an image on the screen by transmission of light from the light-emitter with a transmittance based on input image data; and
a storage configured to store color change information showing a change in color of light from the light source in an in-plane direction of the screen,
the method including:
a determining step of determining emission brightness of each light source separately, based on the input image data; and
a color correcting step of performing color correction processing of correcting at least one of a color of each pixel of image data in a target area, and an emission color of the light source corresponding to the target area, based on the color change information.
